(19) United States
(12) Patent Application Publication
(10) Pub. No.: US 2011/0222071 A1
(43) Pub. Date: Sep. 15, 2011

(54) METHOD FOR MEASURING THE THICKNESS OF A DISCOIDAL WORKPIECE

(75) Inventors: Ingo Grotkopp, Kiel (DE); JöRN Kanzow, Kiel (DE); JöRG Meyer, Rickert (DE)

(73) Assignee: PETER WOLTERS GMBH, Rendsburg (DE)

(21) Appl. No.: 13/121,787

(22) PCT Filed: Aug. 29, 2009
(86) PCT No.: PCT/EP09/06275

§ 371 Date: May 27, 2011

(30) Foreign Application Priority Data
Oct. 1, 2008 (DE) 10 2008 049973.0

(51) Int. Cl. G01B 11/06

(52) U.S. Cl. 356/503

(57) ABSTRACT

The invention relates to a method for measuring the thickness of a discoidal workpiece, which serves as a substrate for electronic components, comprising the steps: infrared radiation is directed at the top side of the workpiece, wherein a first radiation portion is reflected on the top side and a second radiation portion penetrates the workpiece thickness, is reflected on the bottom side of the workpiece and emerges again on the top side of the workpiece, the first and the second radiation portion interfere under formation of an interference pattern and the optical workpiece thickness between the top side of the workpiece and the bottom side of the workpiece is determined using the interference pattern. It is provided according to the invention that the mechanical workpiece thickness is determined from a measurement of the intensity of the infrared radiation reflected and/or transmitted from the workpiece.

### CROSS-REFERENCE TO RELATED APPLICATIONS

This is a national stage entry from PCT/EP2009/006275 with an international filing date of Aug. 29, 2009, which claims priority to DE 10 2008 049973.0, filed Oct. 1, 2008, the entire contents of each of which are hereby incorporated by reference.

### STATEMENT REGARDING FEDERALLY SPONSORED RESEARCH

Not applicable

### BACKGROUND OF THE INVENTION

The invention relates to a method for measuring the thickness of a discoidal workpiece, which serves as a substrate for electronic components, comprising the steps: Infrared radiation is directed at the top side of the workpiece, wherein a first radiation portion is reflected on the top side and a second radiation portion penetrates the workpiece thickness, is reflected on the bottom side of the workpiece and exits again on the top side of the workpiece, the first and the second radiation portions interfere under formation of an interference pattern and the optical workpiece thickness between the top side of the workpiece and the bottom side of the workpiece is determined using the interference pattern.

Thin discoidal workpieces, for example silicon wafers, are normally processed in double-sided or single-sided processing machines, for example ground, lapped, polished (“haze free polishing” or “chemical-mechanical polishing”) etc. The geometry of the workpieces thereby created is very important for further use. Thus, the finished workpieces are frequently provided with integrated circuits through optical imaging processes. Undesired variations in the thickness of the workpieces reduce the imaging sharpness and thus the quality of the integrated circuits.

Up until now, a thickness measurement of the workpieces only takes place after the processing in a double-sided processing machine and/or a CMP machine. Based on the measurement result, workpieces are sorted out in the case of an unreliable geometry deviation. This process leads to undesired rejects due to measurement only after completion of the processing. Known methods for thickness measurement are for example laser triangulation, ultrasound and eddy current measuring methods. However, these methods do not offer sufficient accuracy for the discussed, thin, discoidal workpieces. Capacitive thickness measuring methods offer more exact measurement results. However, they are expensive and sensitive.

For example, interferometry comes into question for an online thickness measurement during or shortly before the processing of the workpiece. The optical thickness of the workpiece is thereby determined from the interference pattern by electromagnetic radiation reflected or transmitted by a workpiece to be measured, for example from the separation distance between two interference maximums. The optical thickness is the product of the mechanical thickness and the refraction index of the workpiece material. Thus, if the refraction index is known, the mechanical workpiece thickness can be calculated from the optical workpiece thickness. The refraction index is thereby assumed as the constant specified for the respective workpiece materials to be measured.

However, in practice, the measurement accuracy achievable in this manner is not always sufficient. Thus, fluctuations in the refraction index result from material fluctuations, for example doping fluctuations, of the workpiece, for example of a wafer.

Based on the explained state of the art, the object of the invention is thus to provide a method of the initially named type, with which a more exact thickness measurement of thin discoidal workpieces is possible.

The invention solves this object through the subject of claim 1. Advantageous embodiments can be found in the dependent claims as well as the description and the figures.

For a method of the initially named type, the invention solves the object in that the mechanical workpiece thickness is determined from a measurement of the intensity of the infrared radiation reflected and/or transmitted by the workpiece taking into consideration the optical workpiece thickness.

According to the invention, it has been identified that for example material deviations can lead to variations in the refraction index and thus to a falsification of the thickness measurement. The invention is thereby based on the knowledge that a change in the refraction index impacts the reflection or respectively absorption level of the workpiece and a changed refraction index thus leads to a corresponding change in the reflected or respectively transmitted radiation intensity. The invention takes advantage of this effect in order to compensate for the refraction index deviations during the determination of the mechanical workpiece thickness from the determined optical workpiece thickness.

Depending on the respective material of the workpiece, an impact on the refraction index through a changed absorption due to a changed workpiece thickness can thereby be disregarded in most cases. This applies in particular for substances like silicon, which are highly transparent for infrared radiation. In the case of other substances, it is possible that the absorption of the workpiece also changes when the thickness changes. The refraction index can then be determined in that the measured intensity is corrected by a scale factor determined within the framework of a calibration and showing the changed absorption.

According to the invention, a more exact thickness measurement compared to the state of the art is enabled in the case of deviations for example due to doping fluctuations and improved properties are thus achieved for the application of integrated circuits or individual electronic components.

### BRIEF SUMMARY OF THE INVENTION

With the method according to the invention, thin, discoidal, partially transparent workpieces are measured, which can be designed in particular cylindrically or respectively circularly. The workpieces can have in particular a thickness of less than 1.5 mm. The mechanical workpiece thickness can thereby be calculated as the quotient of the optical workpiece thickness and the refraction index. The determination of the optical workpiece thickness between the workpiece top side and the workpiece bottom side as well as a determination of the refraction index can each take place using suitable calibration characteristics lines or respectively suitable calibration characteristic zones. According to the invention, the side of the workpiece facing the penetrating radiation is called the top side of the workpiece, while the side of the workpiece facing away from the penetrating radiation is called the bottom side of the workpiece. Of course, the method according to the invention is independent of the alignment of the workpiece in space or respectively of the penetration direction of the infrared radiation. It can in particular also be pointed at the workpiece in the vertical direction from bottom to top.

In the case of the internal interferometry used according to the invention, the second radiation portion can naturally pass through the workpiece thickness multiple times and correspondingly can be reflected multiple times on the bottom and if applicable inner surface of the top side before it emerges from the workpiece again. The recording of the interference pattern takes place in particular on the side facing the top side of the workpiece. The infrared radiation can for example thereby be injected into a glass fiber and directed at the workpiece through it or respectively the radiation coming from the workpiece can received by the glass fiber and fed to an analysis. A suitable detector with a suitable electronic evaluation unit can be provided for example for the evaluation of an interference pattern.

The discoidal workpiece can be part of a sandwich structure, wherein the bottom side of the workpiece then forms the boundary surface to the next subjacent layer. The top side of the workpiece can also be the boundary surface to the next upper layer. The interference pattern generated by the interference of the radiation portions can be for example a diffraction pattern or also for example a spectrally fanned out interference pattern analogous to the white light interferometry. According to the invention, the type of interference does not matter.

According to one embodiment, an infrared radiation spectrum can be directed at the top side of the workpiece. This spectrum can in particular be directed at the top side of the workpiece. It is then further possible to spectrally analyze the radiation created by interference of the first and second radiation portions by means of a spectrometer, for example a grating spectrometer. The generally known infrared interferometry proven in practice is used in this embodiment. Infrared lamps, in particular infrared light bulbs or infrared gas discharge lamps, can thereby be used as infrared radiation sources. This thereby leads to interference of the two radiation portions. In particular for certain wavelengths of the spectrum, the path difference created by the workpiece thickness is just enough so that destructive or constructive interference occurs. This interference pattern can then be analyzed spectrally and evaluated by means of a spectrometer. For example, the optical workpiece thickness can be determined from the distance of the two maximums or minimums.

Of course, according to the invention, other interference methods are also conceivable, for example with radiation of high coherence lengths (for example laser radiation) and slanted radiation incidence.

According to another embodiment, for measurement of the intensity of the infrared radiation reflected and/or transmitted from the workpiece, the intensity of the radiation created by interference of the first and second radiation portions can be measured after its reflection on the top side of the workpiece or respectively after its exit from the top side of the workpiece. In this embodiment, the intensity measurement can take place on the same side where the two interfering radiation portions are received and evaluated. Thus, the same measurement arrangement can be used advantageously for the intensity measurement and the evaluation of the interference pattern. A particularly high accuracy can be achieved when an intensity difference between two defined points of the interference pattern, for example an interference maximum and an interference minimum, is determined for the measurement of the intensity. In particular, the minimum can thereby also have an intensity equal to zero.

In accordance with an alternative embodiment, a third radiation portion on the bottom side of the workpiece can exit out of the workpiece and, for the measurement of the intensity of the reflected and/or transmitted infrared radiation, the intensity of the third radiation portion can be measured after its exit from the workpiece. In this embodiment, the intensity of the radiation passing through the workpiece is recorded and used to determine the reflection or respectively absorption level. This embodiment is offered for example when the bottom side of the workpiece is accessible from outside and correspondingly penetrating radiation can be received.

According to another embodiment, the refraction index of the workpiece can be determined and the mechanical workpiece thickness is determined taking into consideration the determined refraction index from the optical workpiece thickness. The refraction index can be determined for example from a characteristic line representing the refraction index depending on the intensity or respectively the intensity difference of the infrared radiation reflected and/or transmitted from the workpiece. Such a characteristic line can be determined within the framework of a calibration. It is also conceivable to determine the mechanical workpiece thickness by means of a characteristic field. Such a characteristic field can represent for example the workpiece thickness depending on the intensity or respectively the intensity difference and the refraction index. Such a characteristic field is normally created within the framework of a calibration. The use of characteristic lines or respectively characteristic fields leads to a particularly simple evaluation of the received radiation.

According to another embodiment, the infrared radiation can be directed laterally over the top side of the workpiece and a mechanical workpiece thickness profile can be determined with the method according to the invention. In this embodiment, the infrared radiation is thus directed one after the other or simultaneously over a plurality of locations lying behind each other in the lateral direction of the workpiece on the top side of the workpiece and the thickness is determined for each of these locations in the manner according to the invention. A lateral thickness profile is this created. According to a related embodiment, the infrared radiation can thereby be directed laterally over the top side of the workpiece and a radial workpiece thickness profile can be determined with the method according to the invention. If a rotational symmetry of the workpiece can be assumed, sufficient accuracy during the thickness measurement is achieved through such a radial measurement. It is thereby possible to direct the infrared radiation in the radial direction of the entire workpiece surface or only a part, for example from the edge up to the midpoint of the workpiece surface or an even smaller area.

In accordance with a particularly practice-appropriate embodiment, the workpiece can be a wafer, in particular a silicon wafer. Such wafers or semiconductor wafers are used in many areas to provide partially complex integrated circuits. The workpiece geometry is thereby particularly important for the quality of the integrated circuit for the initially named reasons. However, other discoidal workpieces are also conceivable for integrated circuits or individual electronic components. The workpiece can thus be for example a sapphire disk. Such substrates can be provided for example with a silicon layer so that they form a sandwich structure. An integrated circuit or an individual component such as a diode or the like can be applied to the silicon layer, for example by means of optical imaging processes.

According to another embodiment, the thickness of a workpiece can be determined with the method according to the invention during and/or shortly before processing of the workpiece in a double-sided processing machine or a single-sided processing machine, for example of a machine for chemical-mechanical planarizing or chemical-mechanical polishing, in particular during the sanding, lapping and/or polishing of the workpiece. It is then also possible to adjust the parameters for the processing of the workpiece during processing depending on the determined thickness and/or the determined thickness profile. With the method according to the invention, such processing machines can optimize an online thickness measurement and optionally an online regulation of the processing parameters depending on the thickness measurement such that the workpiece geometry is optimized. In particular, the purpose of such machines is generally to avoid an undesired concave or undesired convex surface or thickness shape by the processing plate, for example polishing plates. Due to the rotating processing prevalent in such machines, it can be assumed that the workpieces are mainly rotationally symmetrical so that potentially occurring deviations from the specified geometry are also rotationally symmetrical. A radial thickness measurement according to the invention thus provides sufficient accuracy in this case.

### BRIEF DESCRIPTION OF THE SEVERAL VIEWS OF THE DRAWINGS

One exemplary embodiment of the invention is explained in greater detail below using a drawing. The drawing shows schematically in:

FIG. 1 a construction for executing the method according to the invention,

FIG. 2 a sketch for visualization of the beam paths,

FIG. 3 a schematic representation of a workpiece to be measured and

FIG. 4 a radial thickness profile recorded with the method according to the invention.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated.

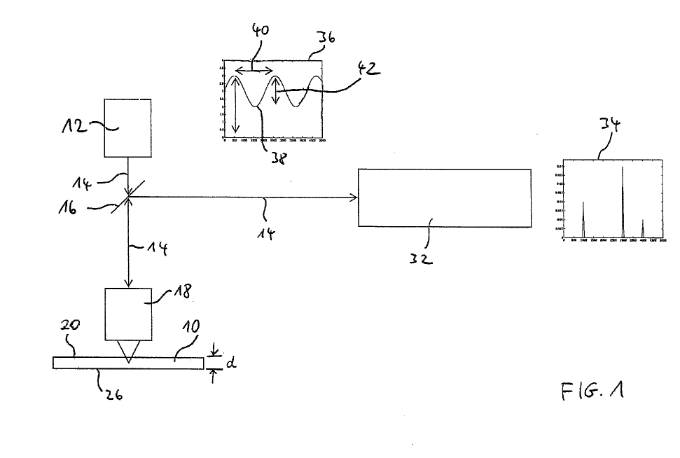

If not specified otherwise, the same reference numbers are used for the same objects in the figures. FIG. 1 shows a discoidal workpiece 10 for an integrated circuit, here a silicon wafer 10, the mechanical thickness d of which needs to be measured. An infrared radiation source 12, here an infrared lamp 12, generates infrared radiation 14, in the shown example an infrared spectrum 14, i.e. infrared radiation distributed over a certain wavelength or respectively frequency area. Through a beam splitter 16, for example a semi-permeable mirror 16, the infrared radiation 14 focused through the optics 18 hits the top side 20 of the wafer under perpendicular incidence.

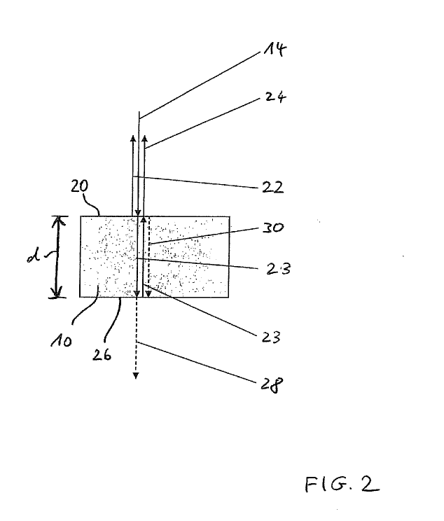

The beam path as it hits the wafer 10 is shown in greater detail in FIG. 2. Accordingly, a first radiation portion 22 is reflected on the top side of the workpiece 20 and returns back perpendicular to the top side 20. Further radiation 23 penetrates the workpiece thickness d, is (partially) reflected on the bottom side of the workpiece 26, penetrates the workpiece thickness d again from the bottom side 26 to the top side 20 and leaves again on the top side of the workpiece at least partially as a second radiation portion 24. The radiation 23 penetrating the workpiece thickness d back from the bottom side of the workpiece 26 to the top side 20 is in turn partially reflected so that another radiation portion 30 penetrates the workpiece thickness d again from the top side 20 to the bottom side of the workpiece 26, etc. These beam paths are generally known. Since the radiation 23 is only partially reflected on the bottom side of the workpiece, a third radiation portion 28 exits on the bottom side of the workpiece 26 in the exemplary embodiment shown in FIG. 2.

The first and second radiation portions 22, 24 (and if applicable further reflected radiation portions) hit the beam splitter 16 again after their reflection or respectively after their re-exit from the workpiece 10 and are deflected from it perpendicularly and are directed to a spectrometer 32. In the example shown, the spectrometer 32 is a grating spectrometer 32. The infrared radiation 14 hitting the spectrometer 32 is spectrally fanned by this spectrometer 32, as shown schematically as spectrum 34 in FIG. 1. In spectrum 34, the radiation intensity in any units over the wavelength is only applied for visualization.

The part of the infrared radiation 14 returning from the wafer 10, in particular the first and second radiation portion 22, 24 interfere with each other in a manner that is also generally known. Constructive or destructive interference results depending on the path difference of the radiation portions 22, 24 caused by the wafer thickness d. A corresponding interference diagram is shown in a general and schematic manner in FIG. 1 with reference number 36. In the interference diagram 36, the intensity in any units is applied over the wavelength. An interference pattern results 38. The thickness d of the workpiece 10 is determined through an evaluation of the intensity signal. For example, from the separation distance 40 between two interference maximum, the optical workpiece thickness L can be determined as a product of the mechanical workpiece thickness d and the refraction index of the wafer 10 in a manner generally known to a person skilled in the art. The intensity difference 42 between an interference maximum and an interference minimum contains information on the reflectivity of the wafer 10. On the basis of the measured intensity difference 42, the refraction index of the wafer 10 can be determined for example based on characteristic line created within the framework of a calibration. On this basis, the mechanical workpiece thickness d can be calculated as a quotient of the determined optical workpiece thickness L and the also determined refraction index n.

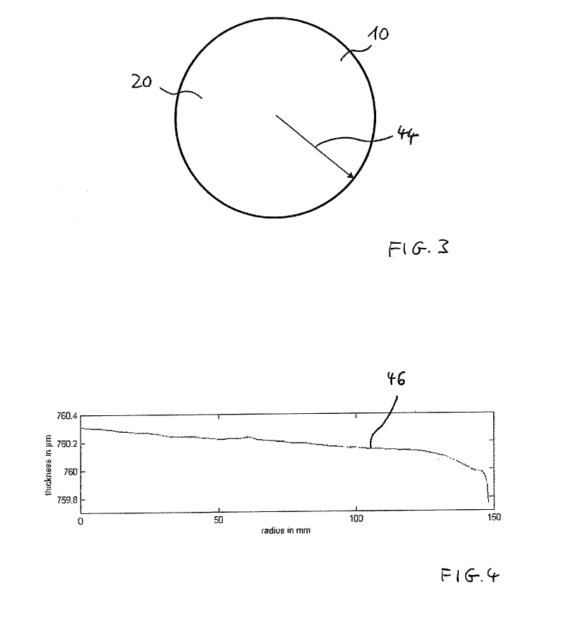

The described method can thereby be used to create a radial thickness profile of a workpiece 10 as shown schematically in FIG. 3. Accordingly, the method is executed along a radial line 44, starting from the midpoint of the cylindrical and circular (from above) workpiece 10 to the edge of the workpiece 10 successively for the surface locations arranged along the radial line 44 and a radial thickness profile is thus created. A corresponding radial thickness profile 46 is shown in FIG. 4. In this diagram, the measured workpiece thickness d is applied in micrometers over the radius of the workpiece 10 in millimeters. The radius 0 describes the midpoint of the top side of the workpiece 20.

With the method according to the invention, a more exact thickness measurement of discoidal workpieces 10, intended to serve as a substrate for electronic components, is possible compared to the state of the art.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

1. A method for measuring the thickness of a discoidal workpiece, which serves as a substrate for electronic components, comprising the steps:
infrared radiation (14) is directed at the top side of the workpiece (20), wherein a first radiation portion (22) is reflected on the top side (20) and a second radiation portion (24) penetrates the workpiece thickness (d), is reflected on the bottom side of the workpiece (26) and exits again on the top side of the workpiece (20),
the first and second radiation portions (22, 24) interfere under formation of an interference pattern,
based on the interference pattern, the optical workpiece thickness (L) between the top side of the workpiece (20) and the bottom side of the workpiece (26) is determined based on the interference pattern,
characterized by the further step:
the mechanical workpiece thickness (d) is determined from a measurement of the intensity of the infrared radiation (14) reflected and/or transmitted from the workpiece (10).

2. The method according to claim 1, characterized in that an infrared radiation spectrum (14) is directed at the top side of the workpiece (20).

3. The method according to claim 2, characterized in that the infrared radiation spectrum (14) is directed perpendicularly at the top side of the workpiece (20).

4. The method according to claim 2, characterized in that the radiation created through interference of the radiation portions (22, 24) is analyzed by means of a spectrometer (32).

5. The method according to claim 1, characterized in that, for measurement of the intensity of the infrared radiation (14) reflected and/or transmitted from the workpiece (10), the intensity of the radiation created by interference of the first and second radiation portions (22, 24) can be measured after its reflection on the top side of the workpiece (20) or respectively after its exit from the top side of the workpiece (20).

6. The method according to claim 1, characterized in that, for the measurement of the intensity of the infrared radiation (14) reflected and/or transmitted from the workpiece (10), an intensity difference (42) is determined between two defined points of the interference pattern, in particular an interference maximum and an interference minimum.

7. The method according to one of claim 1, characterized in that a third radiation portion (28) exits the workpiece (10) on the bottom side of the workpiece (26) and, for measurement of the intensity of the infrared radiation (14) reflected and/or transmitted from the workpiece (10), the intensity of the third radiation portion (28) is measured after its exit from the workpiece (10).

8. The method according to claim 1, characterized in that the refraction index (n) of the workpiece (10) is determined, and the mechanical workpiece thickness (d) is determined taking into account the determined refraction index (n) from the optical workpiece thickness (L).

9. The method according to claim 8, characterized in that the refraction index (n) is determined from a characteristic line representing the refraction index (n) depending on the intensity or respectively the intensity difference (42) of the infrared radiation (14) reflected and/or transmitted from the workpiece (10).

10. The method according to claim 1, characterized in that the mechanical workpiece thickness (d) is determined by means of a characteristic field.

11. The method according to claim 1, characterized in that the infrared radiation (14) is directed laterally over the top side of the workpiece (20) and a mechanical workpiece thickness profile (46) is determined with the method.

12. The method according to claim 1, characterized in that the workpiece (10) is a wafer (10), in particular a silicon wafer (10).

13. The method according to claim 1, characterized in that the workpiece (10) is sapphire disk.

14. The method according to claim 1, characterized in that the thickness (d) of a workpiece (10) is determined during and/or shortly before and/or shortly after a processing of the workpiece (10) in a single-sided or double-sided processing machine, in particular a machine for chemical-mechanical planarizing or chemical-mechanical polishing.

15. The method according to claim 14, characterized in that the parameters for the processing of the workpiece (10) are adjusted depending on the determined thickness (d) and/or the determined thickness profile.

16. A method for measuring the thickness of a discoidal workpiece, which serves as a substrate for electronic components, comprising the steps of:
directing infrared radiation (14) at the top side of the workpiece (20), wherein a first radiation portion (22) is reflected on the top side (20) and a second radiation portion (24) penetrates the workpiece thickness (d), is reflected on the bottom side of the workpiece (26) and exits again on the top side of the workpiece (20);
the first and second radiation portions (22, 24) forming an interference pattern from the directed infrared radiation;
determining the optical workpiece thickness (L) between the top side of the workpiece (20) and the bottom side of the workpiece (26), based on the interference pattern;
determining the mechanical workpiece thickness (d) from a measurement of the intensity of the infrared radiation (14) reflected and/or transmitted from the workpiece (10).
